(19) United States
(12) Patent Application Publication
(10) Pub. No.: US 2021/0345822 A1
(43) Pub. Date: Nov. 11, 2021

(54) Multi-Functional Beverage Maker

(71) Applicant: Hamilton Beach Brands, Inc., Glen Allen, VA (US)

(72) Inventors: Michelle L Johnson, Moseley, VA (US); Adam Hanes, Glen Allen, VA (US)

(21) Appl. No.: 16/868,187

(22) Filed: May 6, 2020

(51) Int. Cl. A47J 31/52; A47J 31/36; A47J 31/46

(52) U.S. Cl. CPC A47J 31/5251; A47J 31/3671; A47J 31/3676; A47J 31/5255; A47J 31/468; A47J 31/461; A47J 31/465

(57) ABSTRACT

A beverage-making machine includes: a housing; an espresso station; a coffee station; a water reservoir; a fluid transport system fluidly connected with the water reservoir, the fluid transport system including a pump configured to provide selectively variable pressure, a heater positioned to heat fluid in the fluid transport system, and a three-way valve fluidly connected with the pump; and a controller configured such that, (a) upon a user's selection to brew espresso, the controller signals the pump to operate at a first, higher operating pressure and signals the three-way valve to direct fluid from the pump to the espresso brewing station, and (b) upon a user's selection to brew coffee, the controller signals the pump to operate at a second, lower operating pressure and signals the three-way valve to direct fluid from the pump to the coffee brewing station.

### FIELD OF THE INVENTION

The present invention relates generally to small appliances, and more specifically to beverage makers.

### BACKGROUND

Automatic drip coffeemakers are well known and widely used. They are effective to brew carafes of coffee, typically containing five to eight cups or more of liquid. Automatic drip coffee makers may also be used for brewing small batches (one to four cups).

A typical automatic drip coffeemaker includes a brew basket that contains ground coffee. The ground coffee is generally in a bowl-shaped filter. Alternatively, it could be within a “pod”-type package that is pierced by needles, such as the disposable coffee pods sold under the trademark K-Cup®. Heated water is conveyed to the brew basket and released, where it gravimetrically flows downwardly through the coffee grounds and into a receptacle such as a carafe or pot. Exemplary automatic drip coffeemakers are discussed in U.S. Pat. No. 5,001,969 to Moore et al.; U.S. Pat. No. 7,066,080 to Hsu; and U.S. Pat. No. 8,065,952 to Wang, the disclosures of which are hereby incorporated herein by reference in full. Some coffeemakers are designed to brew coffee in different forms; for example, coffeemakers offered in the FLEXBREW line of products available from Hamilton Beach Brands (Richmond, Va.) include an insert that enables the user to choose between a pod or loose ground coffee.

As one alternative to conventional coffee, espresso (which is highly concentrated coffee) is quite popular. A large number of espresso making machines are available. Typically espresso machines require the application of high pressure through the grounds to concentrate the ground coffee sufficiently. Some espresso machines utilize a prepacked, disposable “pod” filled with coffee grounds as the coffee source for making espresso. These disposable pods are also pierced at the timing of brewing, which happens under much higher pressure, such as the espresso pods sold under the trademark Nespresso®.

It may be desirable to provide additional coffee-making options to users in a single machine.

### SUMMARY

As a first aspect, embodiments of the invention are directed to a beverage-making machine, comprising: a housing; an espresso station mounted to the housing, comprising an espresso brew chamber, an espresso inlet to the espresso brew chamber, an espresso outlet from the espresso brew chamber, and an espresso receptacle platform positioned to receive brewed espresso from the espresso outlet; a coffee station mounted to the housing, comprising a coffee brew chamber, a coffee inlet to the coffee brew chamber, a coffee outlet from the coffee brew chamber, and a coffee receptacle platform positioned to received brew coffee from the coffee outlet; a water reservoir mounted to the housing; a fluid transport system mounted to the housing and fluidly connected with the water reservoir, the fluid transport system including a pump configured to provide selectively variable pressure, a heater positioned to heat fluid in the fluid transport system, and a three-way valve fluidly connected with the pump, wherein a first outlet of the three-way valve is fluidly connected with the inlet of the espresso station, and wherein a second outlet of the three-way valve is fluidly connected with the inlet of the coffee station; and a controller mounted to the housing and connected with the pump and the three-way valve, the controller configured such that, (a) upon a user's selection to brew espresso, the controller signals the pump to operate at a first, higher operating pressure and signals the three-way valve to direct fluid from the pump to the espresso brewing station, and (b) upon a user's selection to brew coffee, the controller signals the pump to operate at a second, lower operating pressure and signals the three-way valve to direct fluid from the pump to the coffee brewing station.

As a second aspect, embodiments of the invention are directed to a beverage-making machine comprising: a housing; an espresso station mounted to the housing, comprising an espresso brew chamber, an espresso inlet to the espresso brew chamber, an espresso outlet from the espresso brew chamber, and an espresso receptacle platform positioned to receive brewed espresso from the espresso outlet; a coffee station mounted to the housing, comprising a coffee brew chamber, a coffee inlet to the coffee brew chamber, a coffee outlet from the coffee brew chamber, and a coffee receptacle platform positioned to received brew coffee from the coffee outlet; a water reservoir mounted to the housing; a fluid transport system mounted to the housing and fluidly connected with the water reservoir, the fluid transport system including a pump fluidly connected with the espresso inlet of the espresso brewing station and with the coffee inlet of the coffee brewing station, and a heater positioned to heat fluid in the fluid transport system; and a controller mounted to the housing and connected with the pump, the controller configured such that, (a) upon a user's selection to brew espresso, the controller signals the pump to operate to direct fluid from the pump to the espresso station, and (b) upon a user's selection to brew coffee, the controller signals the pump to operate to direct fluid from the pump to the coffee station.

As a third aspect, embodiments of the invention are directed to a beverage-making machine comprising: a housing; an espresso station mounted to the housing, comprising an espresso brew chamber, an espresso inlet to the espresso brew chamber, an espresso outlet from the espresso brew chamber, and an espresso receptacle platform positioned to receive brewed espresso from the espresso outlet; a coffee station mounted to the housing, comprising a coffee brew chamber, a coffee inlet to the coffee brew chamber, a coffee outlet from the coffee brew chamber, and a coffee receptacle platform positioned to received brew coffee from the coffee outlet, wherein the brew chamber is configured to brew both loose grounds of coffee and a coffee cartridge; a water reservoir mounted to the housing; a fluid transport system mounted to the housing and fluidly connected with the water reservoir, the fluid transport system including a pump fluidly connected with the espresso inlet of the espresso brewing station and with the coffee inlet of the coffee brewing station, and a heater positioned to heat fluid in the fluid transport system; and a controller mounted to the housing and connected with the pump, the controller configured such that, (a) upon a user's selection to brew espresso, the controller signals the pump to operate to direct fluid from the pump to the espresso station, and (b) upon a user's selection to brew coffee, the controller signals the pump to operate to direct fluid from the pump to the coffee station.

### BRIEF DESCRIPTION OF THE FIGURES

FIG. 1 is a front perspective view of a multi-functional coffeemaker according to embodiments of the invention.

FIG. 2 is a rear perspective view of the coffeemaker of FIG. 1.

FIG. 3 is a schematic diagram of the fluid transport assembly of the coffeemaker of FIG. 1.

FIG. 4 is a rear perspective view of the coffeemaker of FIG. 1 with the rear cover removed that shows some of the components of the fluid transport assembly.

FIG. 5 is a partial side perspective view of the three-way valve and the X-connector of the fluid transport assembly of the coffeemaker of FIG. 1.

FIG. 6 is a partial side perspective view of the three-way valve and air pump connection (shown partially schematically) of the coffeemaker of FIG. 1.

FIG. 7 is a partial side perspective view of the three-way valve and pressure relief valve connection (shown partially schematically) of the coffeemaker of FIG. 1.

FIG. 8 is a rear, partially schematic view of the three-way valve and its connection to the espresso station.

FIG. 9 is a side section view of the espresso station of the coffeemaker of FIG. 1 with an espresso pod in place.

FIG. 10 is an enlarged partial front perspective view of the cover of the chamber of the espresso chamber of FIG. 9.

FIG. 11 is a side view of the espresso station of the coffeemaker of FIG. 1, shown in the closed position.

FIG. 12 is a side view of the espresso station of FIG. 11 with the mounting wall removed.

FIG. 13 is a side view of the espresso station of the coffeemaker of FIG. 1, shown in the open position.

FIG. 14 is a side view of the espresso station of FIG. 13 with the mounting wall removed.

FIG. 15 is a side view of the coffee station of the coffeemaker of FIG. 1.

FIG. 16 is a side section view of the coffee station of FIG. 15.

FIG. 17 is a perspective view of an adapter for coffee cartridge to be used with the coffee station of FIG. 15.

FIG. 18 is a perspective view of an adapter for loose grounds of coffee to be used with the coffee station of FIG. 15.

### DETAILED DESCRIPTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

In the figures, certain layers, components or features may be exaggerated for clarity, and broken lines illustrate optional features or operations unless specified otherwise. This invention may, however, be embodied in many different forms and should not be construed as limited to the embodiments set forth herein; rather, these embodiments are provided so that this disclosure will be thorough and complete, and will fully convey the scope of the invention to those skilled in the art.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention. The sequence of operations (or steps) is not limited to the order presented in the claims or figures unless specifically indicated otherwise.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

Referring now to the drawings, a multi-functional coffeemaker, designated broadly at 10, is shown in FIG. 1. The coffeemaker 10 has both a coffee station 12, which is configured to brew conventional coffee from either loose grounds or a pod, and an espresso station 14, which is configured to brew espresso from a pod. The coffee station 12 is activated via a control panel 202, and the espresso station 14 is activated via a control panel 204.

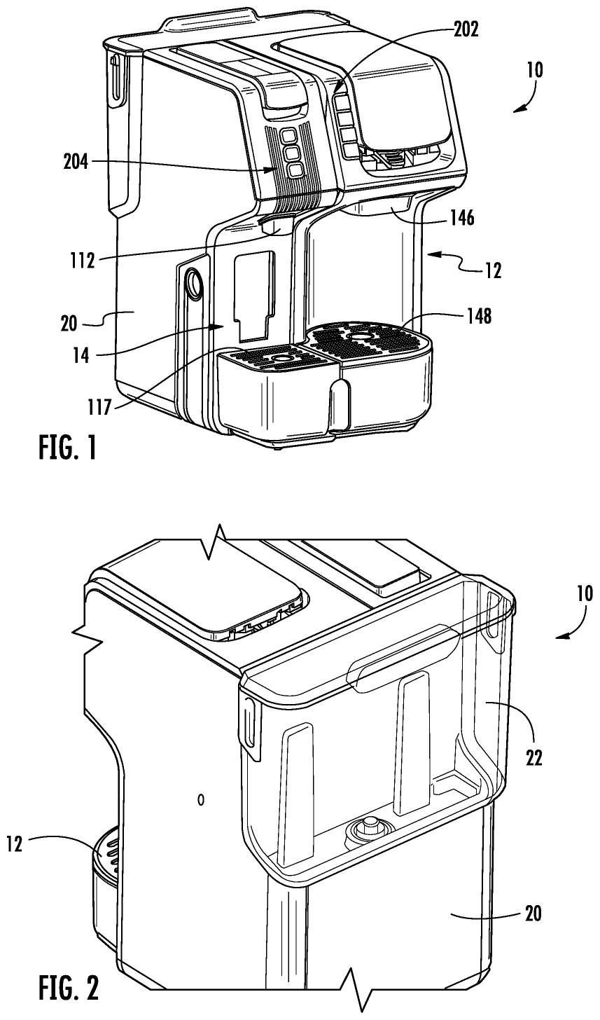

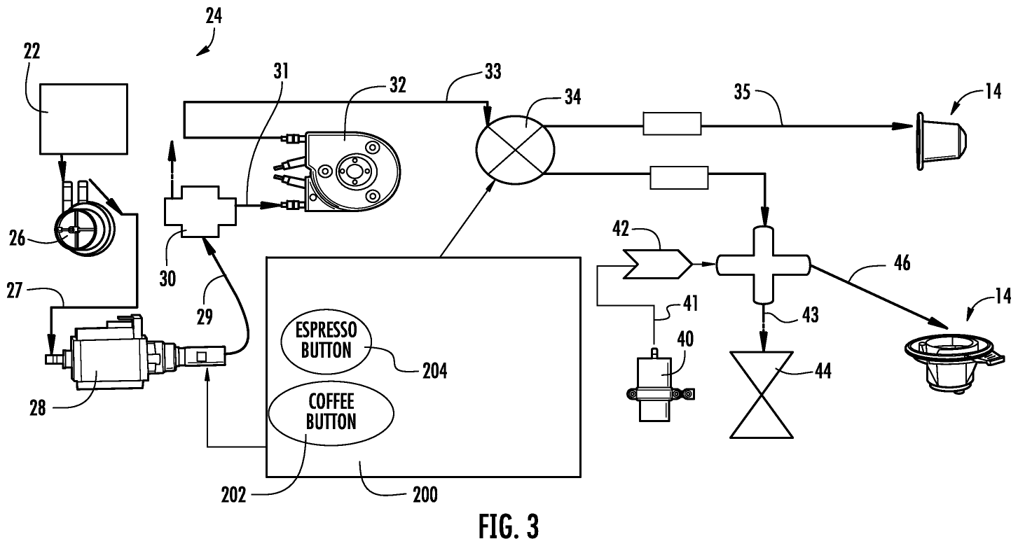

The coffeemaker 10 has an overall housing 20 that covers the exterior of the device. The espresso and coffee stations 14, 12 are positioned in the front part of the housing 20. As shown in FIG. 2, a water reservoir 22 is removably mounted on the upper rear portion of the housing 20. The water reservoir 22 is fluidly connected with a fluid transport assembly 24 that selectively conveys fluid (typically water) from the water reservoir 22 to either the espresso station 14 or the coffee station 12 (see FIG. 3).

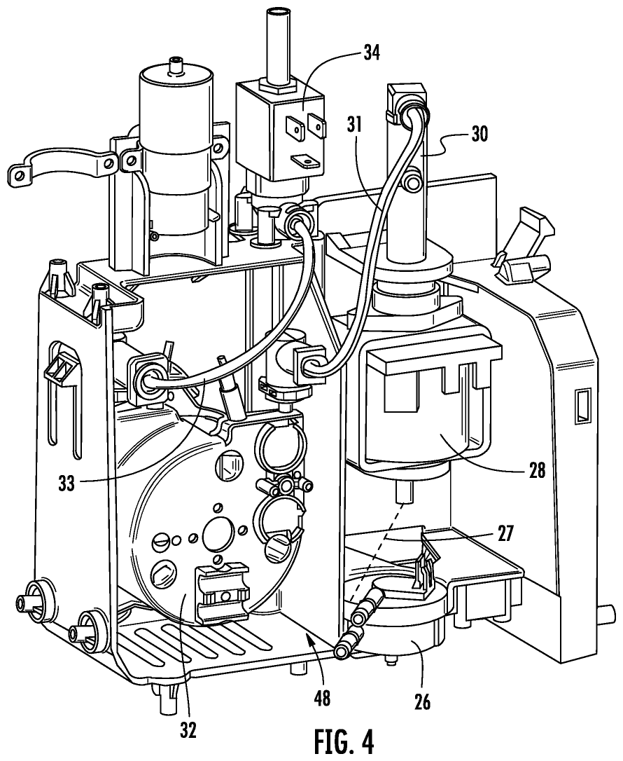

The fluid transport assembly 24 is illustrated in FIG. 3 and shown schematically in FIG. 4. The fluid transport assembly 24 receives water from the water reservoir 22 in a flow meter 26 via a line 25. The flow meter 26, which may be of conventional design, operates to provide water at a desired flow rate (typically about 150-200 cc/min).

The flow meter 26 is fluidly connected with a selectively variable pressure pump 28 via a line 27. The pump 28 can be controlled (via a controller 200, described below) to operate to produce a higher pressure (e.g., 6-22 bar) for the brewing of espresso, or at a lower pressure (e.g., 0-10 psi) for the brewing of coffee. The pump 28 illustrated herein is a vibratory pump, but the pump may be of any configuration capable of selective variable pressure output. Also, as used herein the term “pump” is intended to encompass both a single pump and a multiple pump system.

The fluid transport assembly 24 also includes a pressure relief valve 30 that is fluidly connected with the pump 28. Although shown in FIG. 3 as being connected with a line 29, it will be understood that this description includes embodiments in which the pressure relief valve 30 is integrated with the pump 30. The pressure relief valve 30 is typically rated to prevent the pressure at this point in the assembly 24 from reaching a specified upper threshold (e.g., 25 bar).

The fluid transport assembly 24 further includes a flow-through heater 32 fluidly connected with the pressure relief valve 30 via a line 31. The heater 32, which may be of conventional design, heats fluid flowing therethrough to a desired temperature (typically between about 190 and 205 degrees F. for coffee).

The fluid transport assembly 24 includes a three-way valve 34 (in some embodiments, the three-way valve 34 may be a solenoid valve) that is fluidly connected with the heater 32 via a line 33. A check valve 32a is positioned between the heater 32 and the three-way valve 34; in the illustrated embodiment, the check valve 32a is located within the connector between the line 33 and the heater 32. The three-way valve 34 is operatively connected with and controlled by the controller 200 (described below) that receives user-generated signals from one of the control panels 202, 204 that designates which type of beverage (i.e., espresso or conventional coffee) is to be brewed, and in turn which of the coffee or espresso stations 12, 14 is to be operated.

An espresso line 35 is fluidly connected to one outlet of the three-way valve 34 and is routed to the espresso station 14. A coffee line 37 fluidly connects the other outlet of the three-way valve 34 and an inlet branch of an X-connector 38 (a check valve 38a may be present, and in some embodiments may reside within the X-connector 38 itself). An air pump 40 is fluidly connected via a line 41 (through a check valve 42) to one branch of the X-connector 38. A pressure relief valve 44 (typically rated at about 5 psi) is fluidly connected via a line 43 to another branch of the X-connector 38. The pressure relief valve 44 is connected back to the water reservoir 22 via the line 43 (and may, as in the illustrated embodiment, reside within the X-connector 38). A final line 46 is routed from the remaining branch of the X-connector 38 to the coffee station 12.

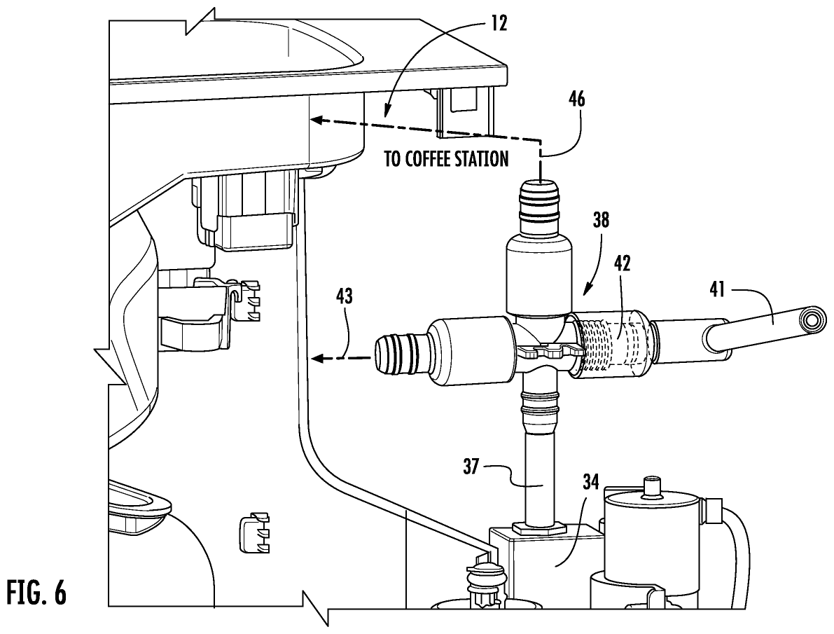

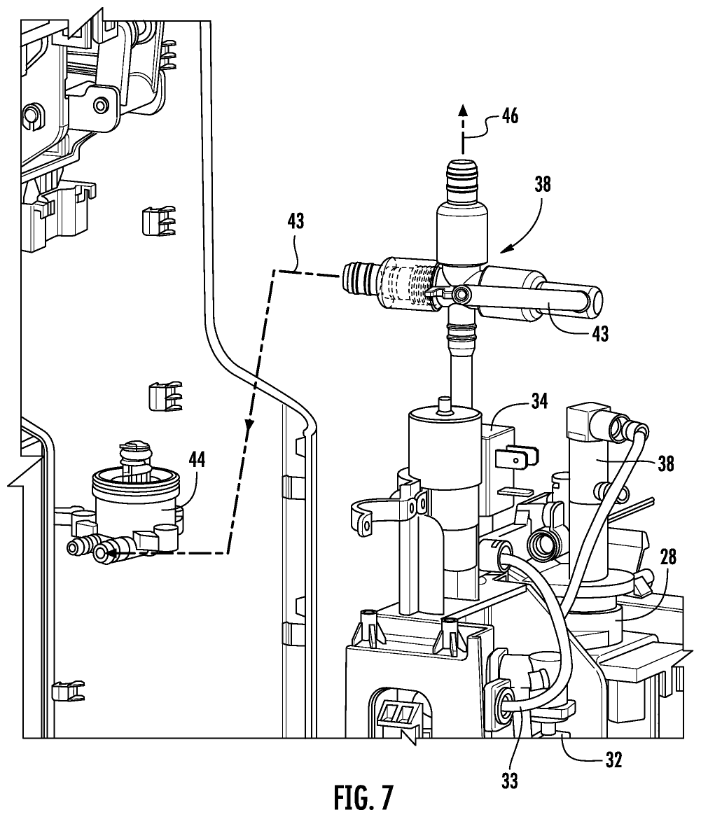

FIGS. 4-8 show the relative positions of the components of the fluid transport system 24 within the housing 20. The flow meter 26 is located toward the rear of the coffeemaker 10, near the bottom and below the water reservoir 22. The pump 28 is located above the flow meter 26 and is fed by the line 27. The pressure relief valve 30 is positioned above the pump 28 (and may be attached directly to the discharge outlet of the pump 28). The flow-through heater 32 is located near the bottom of the coffeemaker 10 within a chamber 48, which may be enclosed from the remainder of the coffeemaker 10 and thermally insulated. The three-way valve 34 is positioned on top of the chamber 48 (near the center of the coffeemaker, between the espresso station 12 and the coffee station 14) and is fed by the line 33.

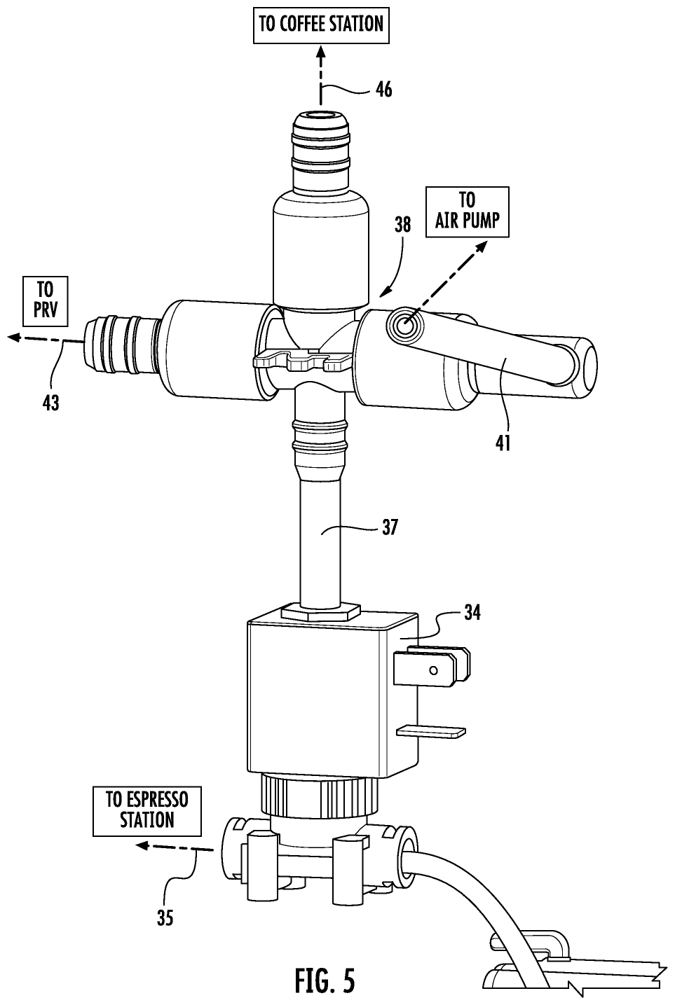

Referring now to FIG. 5, it can be seen that the espresso line 35 is routed from a side of the three-way valve 34 to the espresso station 14. The coffee line 37 extends upwardly to the X-connector 38. The air pump 40 and check valve 42 are connected via the line 41 to one of the lateral branches of the X-connector 38. The opposite branch of the X-connector 38 is connected to the pressure relief valve 44 via the line 43. The line 46 is routed from the upper branch of the X-connector 38 to the coffee station 12; a check valve 38a is included in this path, and may reside within the X-connector 38a.

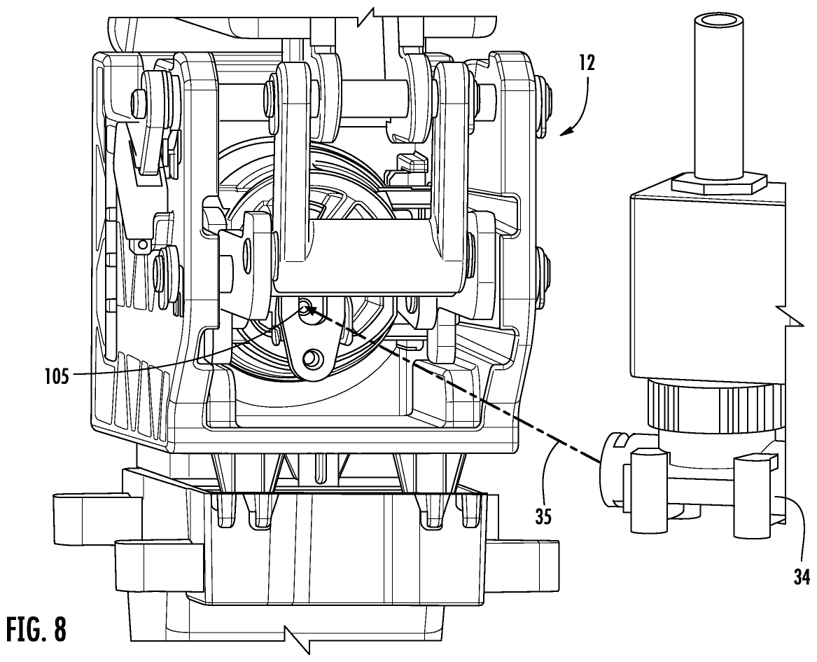

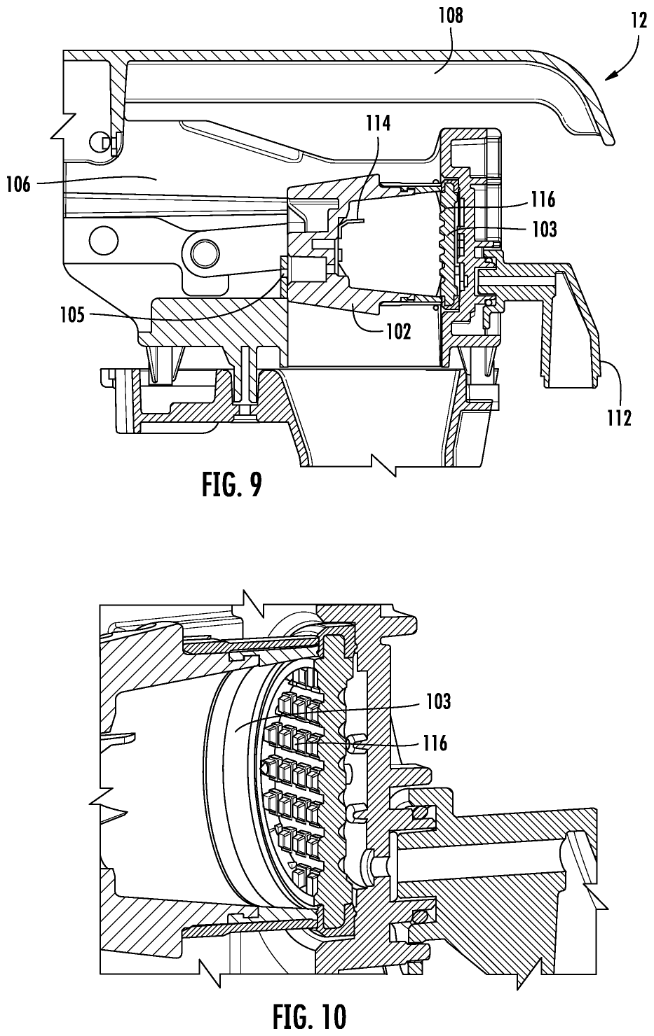

The espresso station 14 is of conventional design and is shown in FIGS. 9-14. The espresso station 14 includes an espresso brew chamber 102 with a cover 103 that is configured to receive an espresso pod E. An inlet 105 is present in the floor of the chamber 102 and is attached to the espresso line 35. A linkage 104 is attached to the chamber 102 and to stationary walls 106. An actuation lever 108 is attached to the linkage 104. A switch 110 is positioned for engagement by the lever 108. An outlet nozzle 112 is positioned forwardly of the cover 103. An espresso receptacle platform 117 is positioned below the outlet nozzle 112.

As shown in FIG. 9, the floor of the chamber 102 includes one or more teeth 114 that are positioned to puncture the lower end of the espresso pod E. The cover 103 includes a plurality of hollow pointed cones 116 that are configured to pierce the foil end of the espresso pod E.

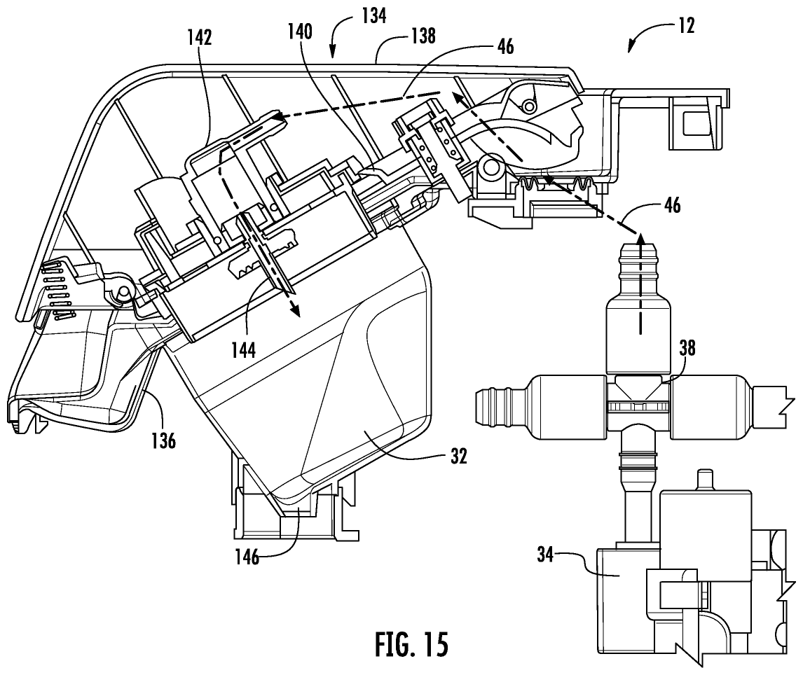

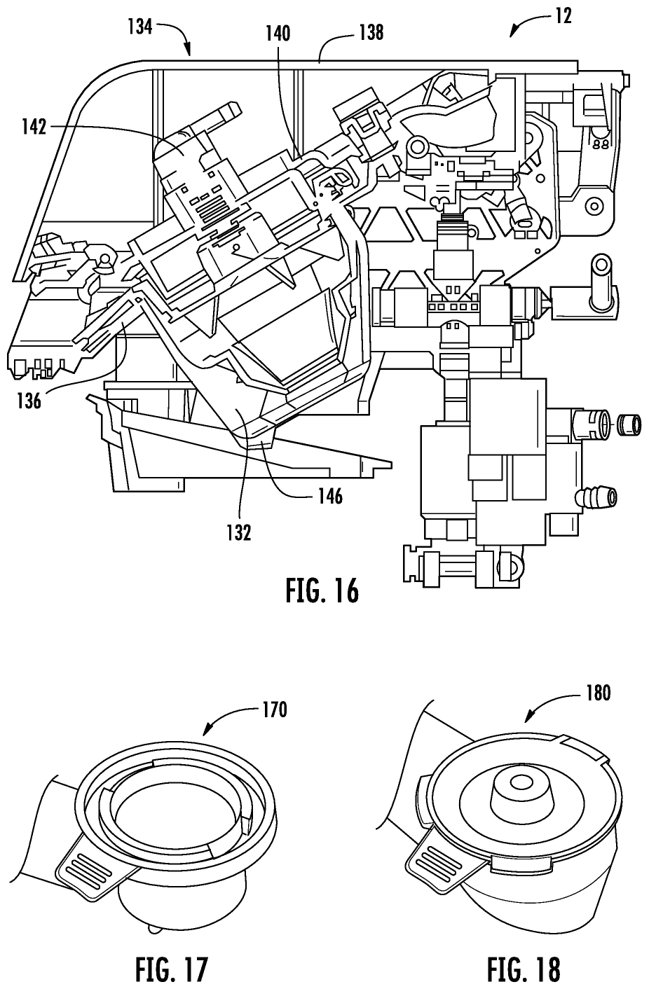

Referring now to FIG. 15, the coffee station 12 is shown therein and includes a coffee brew basket 132 that is mounted beneath a pivoting lever 134. The coffee brew basket 132 depends from a foundation 136. The lever 134 has an outer cover 138 and an inner cover 140 that form a hollow cavity. A fitting 142 is mounted in the inner cover 140; the fitting 142 is in fluid communication at one end with the coffee line 46 and at the opposite end with a hollow needle 144 that extends into the brew basket 132 and serves as the inlet thereto. An outlet 146 extends from the bottom surface of the brew basket 132. A coffee receptacle platform 148 is positioned below the outlet 146 of the brew basket 132.

Notably, the brew basket 132 is configured so that it is “dual-brewing,” meaning that it can receive either loose grounds of coffee (either in a filtering packet or loose in a filter) or a coffee pod. If a coffee pod is to be used, typically a pod insert or adapter (shown at 170 in FIG. 17)) is positioned within the brew basket 132, with the pod placed therein. The insert or adapter 170 typically includes structure, such as hollow needle in its base, that can pierce or puncture the pod at or near the lower end to provide an outlet therefrom. If loose grounds are to be brewed, another adapter configured to brew loose grounds (shown at 180 in FIG. 18) or a packet containing same may be positioned in the brew basket 132. Such an adapter typically includes porous “filter” sections that enable water to drain therefrom while retaining coffee in the brew basket 132. In either event, the adapter 170, 180 and the inner cover 140 form a coffee brew chamber. An exemplary dual-brewing arrangement of this type is discussed in U.S. Patent Publication No. 2014/0208952 to Starr et al., the disclosure of which is hereby incorporated herein in its entirety.

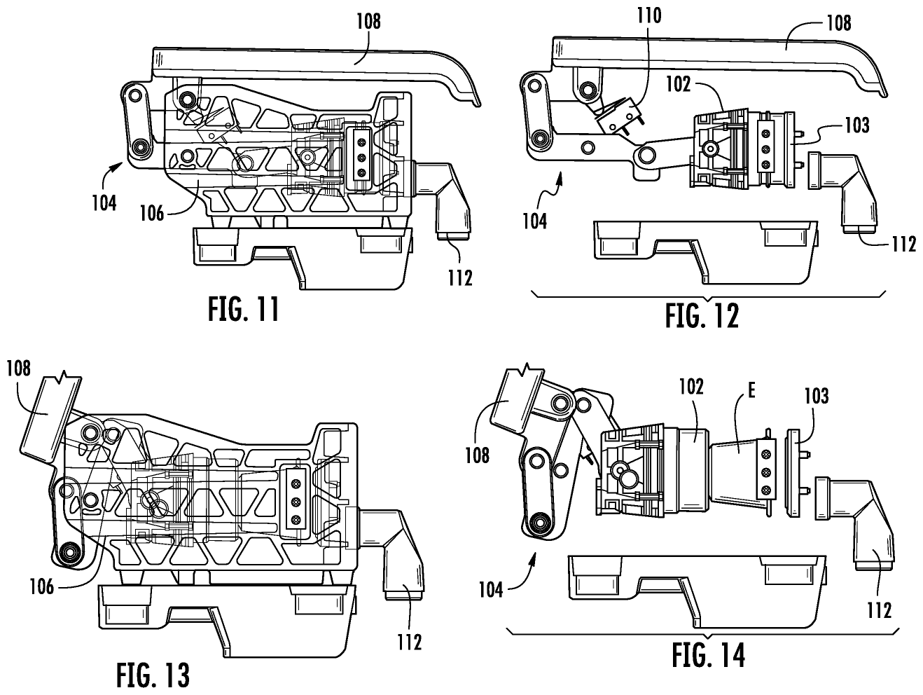

In operation, a user fills the water reservoir 22 with water. If espresso is to be selected, the user inserts an espresso pod E into the chamber 102 of the espresso station 14, with the actuation lever 108 in the raised position of FIGS. 13 and 14, and encloses the espresso pod E in the chamber 102 by pivoting the lever 108 to the lowered position of FIGS. 11 and 12. Pivoting of the lever 108 forces the chamber 102 and inserted pod E forwardly into the cover 103. The teeth 114 puncture the lower surface of the pod E, and the cones 116 puncture the top surface (usually foil) of the pod E, thereby creating a fluid path through the pod E. The user also places a cup or other receptacle on the espresso receptacle platform 117.

The user then selects “espresso” by depressing one of the buttons on the espresso control pad 204. This selection signals the controller 200 to initiate the pump 28. Because “espresso” is selected, the pump 28 operates to pump water at a relatively elevated pressure (e.g., 15-20 bar). Water is pumped from the water reservoir 22 through the flow meter 26, the line 27, the pump 28 and the pressure relief valve 30 and into the heater 32 via the line 31. The water is heated in the heater 32 to a desired temperature (e.g., 190-205° F.) and directed to the three-way valve 34 via the line 33.

Because the user has selected “espresso”, the controller 200 signals the three-way valve 34 to direct the heated water to the espresso station 14 through the espresso line 35. The water enters the chamber 102 through the inlet 105 flows through the pod E, entering through the holes formed by the teeth 114 as water and exiting through the holes formed by the cones 116 as espresso. Once in the nozzle 112, the espresso drains into the cup or other receptacle on the espresso receptacle platform 117.

Notably, the pressure relief valve 30 can prevent the pressure in the system from exceeding a predetermined level (e.g., 25 bar). This can help to prevent overpressuring of the espresso station 14, which can in turn prevent overpressured espresso from being expelled from the outlet nozzle 112.

Also, when the brewing of espresso is complete, the controller 200 signals the three-way valve 34 to return to a condition in which it is “open” toward the coffee station 12 (i.e., toward the coffee line 37). At this point, there may still be heat in the system that can cause a small pressure build-up that would tend to force water out of the coffee line 37 and through the coffee station, giving the user the impression of leaking. The check valve 32a can prevent such pressure build-up and, in turn, prevent any leakage from the coffee station 12.

If the user instead wishes to select conventional coffee, the user inserts either loose grounds (typically within a filter or packet, and in many instances with an accompanying adapter such as the adapter 180 described above) or a pod (typically with the accompanying adapter 170 described above) into the brew basket 132 while the lever 134 is pivoted to a raised position. The lever 134 is then pivoted to a lowered position; if a pod is employed, lowering of the lever 134 causes the needle 144 to puncture the upper surface of the pod, and the aforementioned blade on the adapter to pierce the lower front edge of the pod. The user also places a cup or other receptacle on the coffee receptacle platform 148.

The user then depresses one of the buttons on the coffee control panel 202 to select “coffee.” Depression of a button signals the controller 200 to activate the pump 28. However, because “coffee” has been selected, the pump 28 operates to produce a much lower pressure (e.g., 0 to 10 psi). The path of water from the reservoir 22 to the three-way valve 34 is the same as described above for espresso. However, selecting “coffee” causes the controller 200 to signal the three-way valve 34 to direct the heated water to the coffee station 14. More specifically, the heated water passes through the three-way valve 34 into the X-connector 38 through the coffee line 37. From the X-connector 38, the heated water travels through the check valve 38a and the line 46 to the fitting 142 of the coffee station 12, and then into and through the needle 144 to the brew basket 132. Brewed coffee drains from the brew basket 132 through the outlet 146 into the cup or other receptacle on the coffee receptacle platform 148.

The air pump 40 is activated to provide relatively low pressure air (e.g., 5-15 psi) to dry out the coffee grounds after brewing is complete and the water pump 28 shuts off. This action can prevent dripping of coffee through the outlet 146 after brewing. The check valve 42 prevents water from flowing backward from the X-connector 38 through the line 41 to the air pump 40. The pressure relief valve 44 can prevent overpressuring of the system (e.g., if the needle 144 were to become clogged with coffee grounds). The check valve 38a can prevent any back pressure from drawing coffee grounds back through the needle 146 and into the system, which might otherwise happen if the user interrupted the brew cycle by opening the brew chamber prior to turning the unit off.

Those skilled in this art will appreciate that the beverage maker 10 may take other forms. For example, the espresso station 14 may employ a different mechanism for holding and/or piercing the espresso pod E. Similarly, the coffee station 12 may take a different form; for example, rather than being configured to receive and process either pods or loose grounds, it may be configured to receive and process only one or the other. If the coffee station 12 is configured to brew from a pod, it may have a different mechanism for holding and/or piercing the pod. Other variations may also be suitable for use herein.

In addition, various components of the fluid transport system 24 may be varied. For example, the flow meter 26 may be configured differently, may be combined with a flow control outlet in the water reservoir 22, may be combined with the pump 28, or may be omitted.

The pump 28 is described as a vibratory pump, but may take another form (e.g., a peristaltic pump) that can provide selectively variable pressure. The pump (in the form of a multiple pump system) may also be deployed downstream of the three-way valve, such that individual pump units serve the espresso and coffee stations.

The pressure relief valve 30 may provide pressure relief at a different pressure, or may be located in a different position (e.g., downstream of the heater 32).

The heater 32 is illustrated and described as a flow-through heater, but other heater varieties (e.g., a heat exchanger) may also be employed.

The three-way valve 34 is described as a solenoid valve, but may be any valve that can be controlled by the controller 200. The term “three-way valve” may also encompass embodiments that include an arrangement in which two two-way valves that are attached on the outlet lines of a T-connector are controlled by the controller 200 such that one remains open while the other remains closed, and vice versa. Other combinations and configurations may also be employed.

The portion of the fluid transport system 24 between the three-way valve 34 and the coffee station 12 may also vary from that shown. For example, in some embodiments, either or both of the air pump 40 and the pressure relief valve 44 may be omitted.

In addition, it should be understood that, although the coffeemaker 10 is designed to produce coffee, other beverages, such as tea, hot chocolate, broth, or the like, may be produced with the device, particularly using either a pod or loose leaves in the coffee station 12.

The foregoing is illustrative of the present invention and is not to be construed as limiting thereof. Although exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

That which is claimed is:

1. A beverage-making machine, comprising:
a housing;
an espresso station mounted to the housing, comprising an espresso brew chamber, an espresso inlet to the espresso brew chamber, an espresso outlet from the espresso brew chamber, and an espresso receptacle platform positioned to receive brewed espresso from the espresso outlet;
a coffee station mounted to the housing, comprising a coffee brew chamber, a coffee inlet to the coffee brew chamber, a coffee outlet from the coffee brew chamber, and a coffee receptacle platform positioned to received brew coffee from the coffee outlet;
a water reservoir mounted to the housing;
a fluid transport system mounted to the housing and fluidly connected with the water reservoir, the fluid transport system including a pump configured to provide selectively variable pressure, a heater positioned to heat fluid in the fluid transport system, and a three-way valve fluidly connected with the pump, wherein a first outlet of the three-way valve is fluidly connected with the inlet of the espresso station, and wherein a second outlet of the three-way valve is fluidly connected with the inlet of the coffee station; and
a controller mounted to the housing and connected with the pump and the three-way valve, the controller configured such that, (a) upon a user's selection to brew espresso, the controller signals the pump to operate at a first, higher operating pressure and signals the three-way valve to direct fluid from the pump to the espresso brewing station, and (b) upon a user's selection to brew coffee, the controller signals the pump to operate at a second, lower operating pressure and signals the three-way valve to direct fluid from the pump to the coffee brewing station.

2. The beverage-making machine defined in claim 1, wherein the first operating pressure is above at least 6 bar.

3. The beverage-making machine defined in claim 2, wherein the second operating pressure is below about 15 psi.

4. The beverage-making machine defined in claim 1, wherein the fluid transport system includes a pressure relief valve in fluid communication with the pump and the three-way valve, the pressure relief valve configured to relieve pressure in the fluid transport system above 25 bar.

5. The beverage-making machine defined in claim 1, wherein the fluid transport system includes an air pump pneumatically connected with the coffee station.

6. The beverage-making machine defined in claim 1, wherein the fluid transport system further includes a pressure relief valve fluidly connected with the coffee station that is configured to relieve pressure between the three-way valve and the inlet to the coffee brew chamber.

7. The beverage-making machine defined in claim 1, wherein the controller is operatively connected with a first display panel that is configured to enable the user to select the brewing of espresso, and with a second display panel that is configured to enable the user to select the brewing of coffee.

8. A beverage-making machine, comprising:
a housing;
an espresso station mounted to the housing, comprising an espresso brew chamber, an espresso inlet to the espresso brew chamber, an espresso outlet from the espresso brew chamber, and an espresso receptacle platform positioned to receive brewed espresso from the espresso outlet;
a coffee station mounted to the housing, comprising a coffee brew chamber, a coffee inlet to the coffee brew chamber, a coffee outlet from the coffee brew chamber, and a coffee receptacle platform positioned to received brew coffee from the coffee outlet;
a water reservoir mounted to the housing;
a fluid transport system mounted to the housing and fluidly connected with the water reservoir, the fluid transport system including a pump fluidly connected with the espresso inlet of the espresso brewing station and with the coffee inlet of the coffee brewing station, and a heater positioned to heat fluid in the fluid transport system; and
a controller mounted to the housing and connected with the pump, the controller configured such that, (a) upon a user's selection to brew espresso, the controller signals the pump to operate to direct fluid from the pump to the espresso station, and (b) upon a user's selection to brew coffee, the controller signals the pump to operate to direct fluid from the pump to the coffee station.

9. The beverage-making machine defined in claim 8, wherein the controller is configured such that (a) upon the user's selection to brew espresso, the controller signals the pump to operate at a first, higher operating pressure, and (b) upon the user's selection to brew coffee, the controller signals the pump to operate at a second, lower operating pressure.

10. The beverage-making machine defined in claim 9, wherein the first operating pressure is above at least 6 bar.

11. The beverage-making machine defined in claim 10, wherein the second operating pressure is below about 15 psi.

12. The beverage-making machine defined in claim 9, wherein the fluid transport system includes a pressure relief valve in fluid communication with the pump and the three-way valve, the pressure relief valve configured to relieve pressure in the fluid transport system above 25 bar.

13. The beverage-making machine defined in claim 8, wherein the fluid transport system includes an air pump pneumatically connected with the coffee station.

14. The beverage-making machine defined in claim 8, wherein the fluid transport system further includes a pressure relief valve fluidly connected with the coffee station that is configured to relieve pressure between the three-way valve and the inlet to the coffee brew chamber.

15. The beverage-making machine defined in claim 8, wherein the controller is operatively connected with a first display panel that is configured to enable the user to select the brewing of espresso, and with a second display panel that is configured to enable the user to select the brewing of coffee.

16. A beverage-making machine, comprising:
a housing;
an espresso station mounted to the housing, comprising an espresso brew chamber, an espresso inlet to the espresso brew chamber, an espresso outlet from the espresso brew chamber, and an espresso receptacle platform positioned to receive brewed espresso from the espresso outlet;
a coffee station mounted to the housing, comprising a coffee brew chamber, a coffee inlet to the coffee brew chamber, a coffee outlet from the coffee brew chamber, and a coffee receptacle platform positioned to received brew coffee from the coffee outlet, wherein the brew chamber is configured to brew both loose grounds of coffee and a coffee cartridge;
a water reservoir mounted to the housing;
a fluid transport system mounted to the housing and fluidly connected with the water reservoir, the fluid transport system including a pump fluidly connected with the espresso inlet of the espresso brewing station and with the coffee inlet of the coffee brewing station, and a heater positioned to heat fluid in the fluid transport system; and
a controller mounted to the housing and connected with the pump, the controller configured such that, (a) upon a user's selection to brew espresso, the controller signals the pump to operate to direct fluid from the pump to the espresso station, and (b) upon a user's selection to brew coffee, the controller signals the pump to operate to direct fluid from the pump to the coffee station.

17. The beverage-making machine defined in claim 16, wherein the controller is configured such that (a) upon the user's selection to brew espresso, the controller signals the pump to operate at a first, higher operating pressure, and (b) upon the user's selection to brew coffee, the controller signals the pump to operate at a second, lower operating pressure.

18. The beverage-making machine defined in claim 17, wherein the first operating pressure is above at least 6 bar, and wherein the second operating pressure is below about 15 psi.

19. The beverage-making machine defined in claim 9, wherein the fluid transport system includes a pressure relief valve in fluid communication with the pump and the three-way valve, the pressure relief valve configured to relieve pressure in the fluid transport system above 25 bar.

20. The beverage-making machine defined in claim 8, wherein the fluid transport system includes an air pump pneumatically connected with the coffee station.
